(19) United States
(12) Patent Application Publication
(10) Pub. No.: US 2006/0026435 A1
(43) Pub. Date: Feb. 2, 2006

(54) Method for on-line authenticating a component provided by a supplier

(76) Inventors: Tien-Chieh Wu, Taipei City (TW); Hsueh-Ping Ko, Jhudong Township (TW)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/190,846

(22) Filed: Jul. 28, 2005

(30) Foreign Application Priority Data
Jul. 28, 2004 (TW) 93122549

(51) Int. Cl. H04L 9/00; H04K 1/00

(52) U.S. Cl. 713/182; 713/168

(57) ABSTRACT

A method for on-line authenticating a component provided by a supplier is provided. The method is executed in an electronic dealing system (EDS). At first, an authenticating application form of a component is inputted and an electronic approval of the component is uploaded. Then, a plurality of examining members is assigned by the EDS based on a classification of the component recorded in the authenticating application form. Next, an examination report is uploaded after the samples of the component are examined by the examining members. Finally, an authentication result is generated according to an examination score in the examination report.

### BACKGROUND OF THE INVENTION

1. Field of Invention

The present invention is related to a method for processing information, and particularly to a method for on-line authenticating a component provided by a supplier according to an authentication result generated based on an examination score in an examination report given and uploaded by a plurality of members of examination assigned by an electronic dealing system (EDS).

2. Related Art

In a manufacturing company, a component to be used in a production line must be first authenticated by a quality assurance engineer or a testing engineer. That is, only those components having been authenticated may be used in production and may be bought in by a procurement engineer in the company. Generally, a particular component desired to be authenticated but having not been authenticated by a company is required to be put under an examination and authentication process in the company whenever the particular component is needed for a product in mass or test production, and the authentication process usually lasts up to one to two weeks or more. However, the whole production plan associated with the component may be seriously affected it the time spent on the examination and authentication task is too long, particularly to the case where serious competition is presented and the life cycle of the products becomes shorter and shorter.

For the past practice about a purchasing plan of a component, a purchasing engineer or a research and development (RD) engineer asks a component supplier to provide the component and a testing engineer or a RD engineer subjects the component to an examination and authentication process. Only when the component is determined to be qualified, will the component be allowed to be bought in. In the examination and authentication process of the component, information associated with the component should be passed to the company so that the manufacturer may put the information associated with the component in file and in administration and may be recorded in a component library so as to be searched easily by a purchasing engineer. The information associated with the component comprises information associated with the component specification, information associated with the component manufacturer, information associated with the agent of the component, information associated with the component characteristics and the like. Thereafter, some samples of such component are directed to an examination and authentication process by a quality assurance engineer or a testing engineer. Next, the quality assurance engineer or the testing engineer records the examination result in an examination report based on the component samples examined. Finally, whether the component provided by the AVL supplier is qualified may be determined based on the examination report.

### SUMMARY OF THE INVENTION

It is, therefore, an object of the present invention to provide a method of on-line authenticating a component provided by a supplier by use of an electronic dealing system (EDS), which may shorten the processing time of authentication and electronic storage of authentication documents.

To achieve the afore-mentioned object, the present invention provides a method of on-line authenticating a component provided by a supplier, comprising the steps of submitting a filled authenticating application form of the component and uploading an electronic approval of the component; assigning a plurality of examining members by the EDS based on a classification of the component in the authenticating application form; receiving an examination report after samples of the concerned component are examined by the examining members; and generating an authentication result according to an examination score in the examination report.

The present invention will be described in more detail in terms of the following preferred embodiments with reference to the drawings

### BRIEF DESCRIPTION OF THE DRAWINGS

The invention will become more fully understood from the detailed description given hereinbelow illustration only, and thus are not limitative of the present invention, and wherein:

FIG. 1 is an operating environment which a method of on-line authenticating a component provided by a supplier according to the present invention is executed thereon;

FIG. 2 is a flowchart describing the method of on-line authenticating a component provided by a supplier according to the present invention; and

FIG. 3 is a schematic application form used in the method of authenticating a component provided by a supplier of according to the present invention.

### DETAILED DESCRIPTION OF THE INVENTION

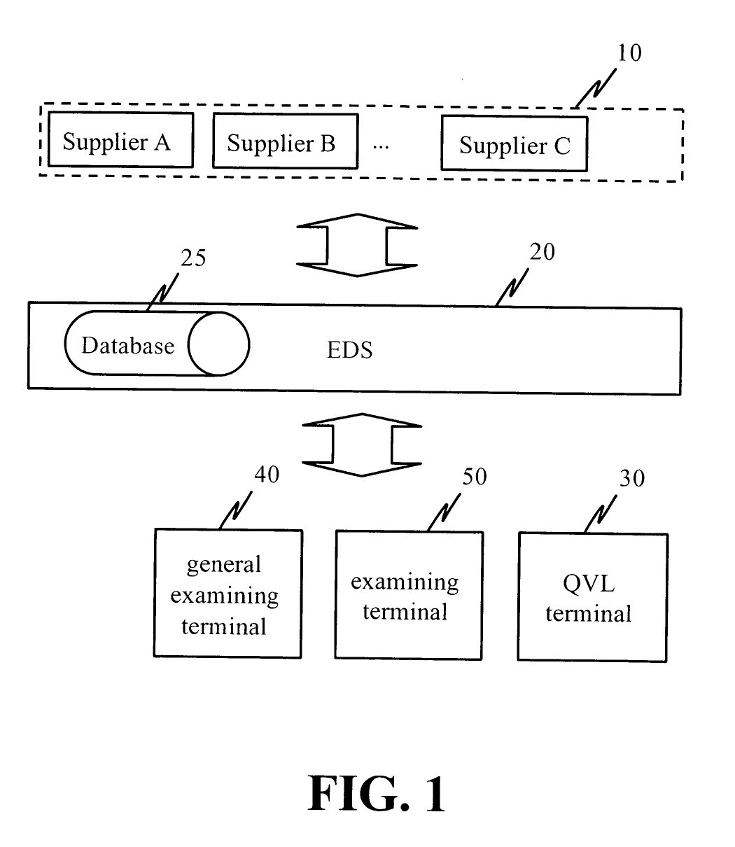

Referring to FIG. 1, an operating environment that a method of on-line authenticating a component provided by a supplier according to the present invention is executed is illustrated therein. As shown in FIG. 1, the operating environment comprises an electronic dealing system (EDS) 20 operated in a server computer and comprising a database 25. In the database 25, an authenticating application form of the component is included. Data can be recorded into the database 25 or fetched from the database 25 according to a request from a client computer, i.e., a potential AVL supplier. The server computer is coupled to the client computer through a network, such as the Internet and transmits a corresponding web page to the client computer, wherein the number of the client computer may be at least one. When the client computer executes a browser, the client computer may be actually coupled to the EDS 20 in the server computer through the network. Then, the client computer will receive the corresponding web page and may input or query information therein. In the client computer, a supplier 10, a QVL terminal 30, a general examining terminal 40 and an examining terminal 50 are included, which may login the EDS 20 through inputting an account and a corresponding password to obtain the corresponding web pages and the operating authorization.

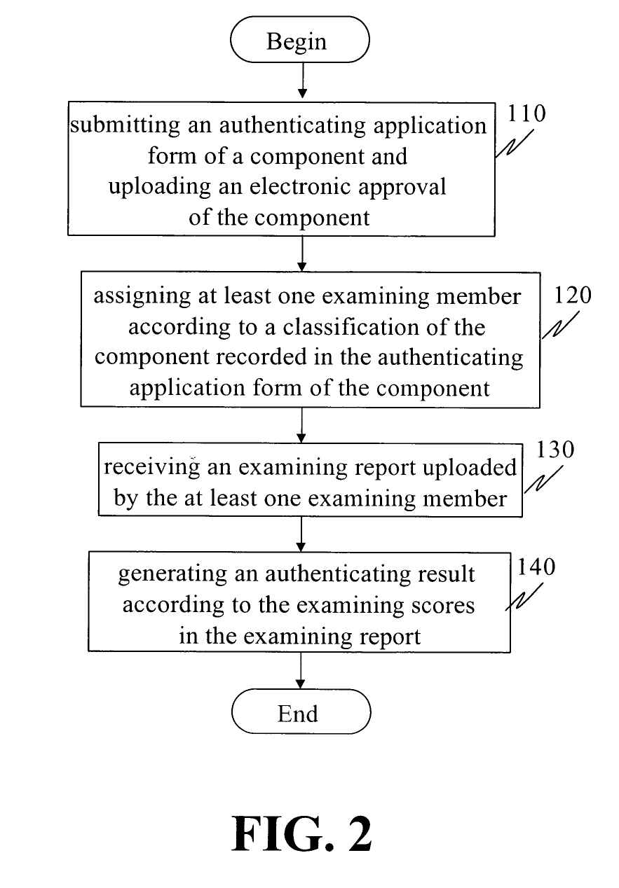

Referring to FIG. 2, a method of on-line authenticating a component provided by a supplier of a preferred embodiment according to the present invention is illustrated therein. When a company has a manufacturing or purchasing plan, the company may request a component supplier to provide samples of the component so that examining members in the company may run a test against the component to see if the component is qualified and thus an authentication can be given. Alternatively, the AVL supplier could initialize a process of authenticating application for its component before the company requests a test. At first, the AVL supplier logins to an EDS 20 in the server computer by using an account and a corresponding password. In response to a correct set of account and password, the EDS 20 displays a corresponding web page where the AVL supplier 10 may fill in and then submit an authenticating application form of the component and upload an electronic approval of the component (step 110). In the authenticating application form, a multiple of steps are included and guided by the EDS 20 and each of the steps corresponds to a field in the authenticating application form. After the authenticating application form of the component is submitted, it is passed to the QVL terminal 30 (typically an administrator of the department of quality assurance or the research and development (RD) department in the company).

The QVL terminal 30 may login to the EDS 20 to read the authenticating application form of the component. According to the classification of the component associated with the authenticating application form, the EDS 20 assigns at least one examining member (step 120) by, for example, selecting at least one examining member from the database 25 and adding the examining member into a candidate list that displays the at least one examining member. The examining member may be selected from the candidate list based on a random assignment scheme and an in-shift assignment scheme or the like. The QVL terminal 30 may change the candidate list so as to add or delete one or more examining members therein. In addition, a general examining member is pre-set by the EDS 20 or assigned among the examining members in the candidate list by the QVL terminal 30. Next, the EDS 20 transmits al application number corresponding to the current application form of examination of the component to the general examining member.

The general examining member 40 logins the EDS 20 to launch an examination process of qualifications of the AVL supplier according to the received application number. This step is to examine whether the application form has been filled in completely and whether the electronic approval of the component has been uploaded. If the examination is qualified, the EDS 20 transmits an examination number corresponding to this examining process to the examining members. In response to the examination number, the examining members may conduct a further examination of the component.

When each of the examining members finishes the examining process, a corresponding web page showing an examination list is presented after he/she logins the EDS 20. At this time, the examining member uploads the examination report (step 130). In the examination report, a description of the component and an examination score are included.

The EDS 20 collects the examination scores in the examination report and generates an authentication result (step 140) to see if the examined component is qualified. Next, the EDS 20 passes the authentication result to the departments associated with the examination process and the department associated for further approving the authentication result. In this regard, the method of on-line authenticating a component provided by a supplier may further comprise a step of approving the authentication result. That is, the departments associated with the examination process may login the EDS 20 to approve the authentication result according to their operating authorization by, for example, sending out a command “Sure” so as to reduce the time spent on the whole authenticating process. Alternatively, the command “Sure” may be replaced by an electronic signature through an electronic signing mechanism or technology. The general examining member can track if all the associated departments have signed for the authenticating result. If not, the general examining member may send out a notification, e.g. an email, for prompting the approving process for the authorization result.

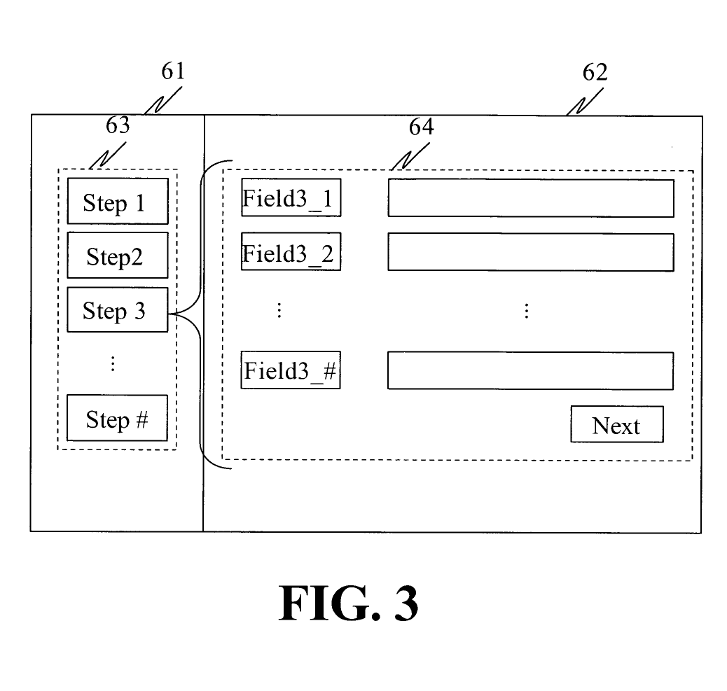

In FIG. 3, a schematic diagram of an application form used in the method of on-line authenticating a component provided by a supplier according to the present invention is illustrated therein. As shown in FIG. 3A, the application form is presented on a displayer of the client computer in a window divided form and has at least an indicator window 61 and a display window 62. The indicator window 61 displays a plurality of guiding steps presented in different blocks 63 to guide the AVL supplier to fill in a plurality sets of information, such as the basic information of the samples of the component, the manufacturer information of the component, the agent information of the component, the price information of the component, the information associated with the maintenance history of the component and the like and upload the electronic approval of the component. Each of the guiding steps shown in the blocks 63 has its corresponding frame in the display window 62. The steps shown in the indicator window 61 includes the finished step(s), the current step and the unfinished step(s) and each of the step groups are represented by its specific color. For example, green color is used to represent the finished step(s), red color is used to represent the current step and blue color is used to represent the unfinished step(s). Each of the steps has a corresponding frame shown in the display window 62 used to show the corresponding field to be inputted. Also, each of the steps is proceeded by order, i.e., a step will be executed only after its proceeding step is finished.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A method of on-line authenticating a component of a supplier applied in an electronic dealing system (EDS) for authenticating the component, comprising the steps of:
submitting an authenticating application form of the component and uploading an electronic approval of the component;
assigning at least one examining member according to a classification recorded in the authenticating application form of the component;
receiving an examination report uploaded by the examining member; and
generating an authentication result according to a plurality of examination scores in the examination report.

2. The method as recited in claim 1, further comprising a step of logining the EDS so that the EDS may approve login information sent by the supplier and display a corresponding web page according to the logining information.

3. The method as recited in claim 1, wherein the authenticating application form comprises an indicator window comprising a plurality of blocks each associated with a plurality of guiding steps respectively and a display window displaying one of a plurality of web pages corresponding to the plurality of guiding steps respectively in the indicator window.

4. The method as recited in claim 3, wherein the plurality of guiding steps comprises filling in a basic information of the component, a manufacturer information of the component, an information associated with the agent of the component and a price information of the component.

5. The method as recited in claim 3, wherein the plurality of guiding steps are divided into a group of finished steps, a group of a current step and a group of unfinished steps and each group is presented with a specific color.

6. The method as recited in claim 1, wherein EDS has a candidate list showing the examining members to be assigned.

7. The method as recited in claim 1, wherein said at least one examining member comprises a general examining member in charge of an authentication over qualifications of the supplier.

8. The method as recited in claim 1, further comprising a step of approving the authentication result by a plurality of departments associated with the authentication of the component.

9. The method as recited in claim 8, wherein the step of approving the authentication result is executed by an electronic signing technology.
